(19) United States
(12) Patent Application Publication
(10) Pub. No.: US 2011/0205150 A1
(43) Pub. Date: Aug. 25, 2011

(54) ELECTRONIC DEVICE

(75) Inventors: Shunichi Saito, Hamura-shi (JP); Shuji Miyamoto, Ome-shi (JP)

(73) Assignee: KABUSHIKI KAISHA TOSHIBA, Tokyo (JP)

(21) Appl. No.: 12/861,731

(22) Filed: Aug. 23, 2010

(30) Foreign Application Priority Data
Feb. 19, 2010 (JP) 2010-035206

(51) Int. Cl. G09G 5/00; G11B 21/02

(52) U.S. Cl. 345/156; 360/97.02; G9B/21.003

(57) ABSTRACT

According to one embodiment, an electronic device includes a main body unit, a hard disk drive housed inside the main body unit and including a head which performs reading and writing of data to a magnetic disk, a display unit pivotable between a first position where the display unit is laid parallel to the main body unit and a second position where the display unit is raised relative to the main body unit, a sensor which senses an angle at which the display unit is positioned, and a control unit. The control unit retracts the head to a retraction position when the sensor senses a change in the angle of the display unit.

### CROSS-REFERENCE TO RELATED APPLICATIONS

This application is based upon and claims the benefit of priority from Japanese Patent Application No. 2010-035206, filed Feb. 19, 2010; the entire contents of which are incorporated herein by reference.

### FIELD

Embodiments described herein relate generally to an electronic device comprising a display unit.

### BACKGROUND

Jpn. Pat. Appln. KOKAI Publication No. 2007-181188 discloses a mobile communication terminal which protects a hard disk drive from shock caused by opening or closing a display. The terminal determines that a user is opening or closing the display when a CPU detects that one of the signals output from an open-state detection switch and a closed-state detection switch goes off. In such a terminal, the head of an HDD is retracted to a safe position as opening or closing of the display is completed to prevent failure of the disk and head of the HDD due to shock imparted to the terminal.

To be more specific, the open-state detection switch remains on from the state where the display is open to the state where the display is closed to a predetermined angle. The CPU detects closing of the display by the user when the display is closed to the predetermined angle. On the other hand, the closed-state detection switch remains on from the state where the display is closed to the state where the display is opened to a predetermined angle. The CPU detects opening of the display by the user when the display is opened to the predetermined angle.

General electronic devices allow adjustment of the position of the display while it is open; however, the above-mentioned conventional mobile communication terminal does not detect the movement of the display while it is open. Thus the terminal may still be improved.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary perspective view showing a portable computer according to the first embodiment.

FIG. 2 is an exemplary block diagram showing the control structure of the portable computer shown in FIG. 1.

FIG. 3 is an exemplary enlarged perspective view of the circumference of the hinge portion of the portable computer shown in FIG. 1.

FIG. 4 is an exemplary perspective view showing the variable resistor which is a sensor of the portable computer shown in FIG. 3.

FIG. 5 is an exemplary flow chart showing an operation of head retraction of the portable computer according to the first embodiment.

FIG. 6 is an exemplary perspective view showing the rotary encoder which is a sensor of a portable computer according to the second embodiment.

FIG. 7 is an exemplary flow chart showing an operation of paging forward of an electronic book according to the third embodiment.

FIG. 8 is an exemplary perspective view showing the second unit of the electronic book according to the third embodiment placed in the second position.

FIG. 9 is an exemplary perspective view showing the second unit of the electronic book shown in FIG. 8 moved from the second position to the third position.

FIG. 10 is an exemplary perspective view showing a remodeled example of the electronic book according to the third embodiment.

FIG. 11 is an exemplary flow chart showing a process of optimization of brightness and color of the display unit of a portable computer according to the fourth embodiment.

FIG. 12 is an exemplary flow chart showing a process of judgment of replacement of the hinge portion of a portable computer according to the fifth embodiment.

### DETAILED DESCRIPTION

Various embodiments will be described hereinafter with reference to the accompanying drawings.

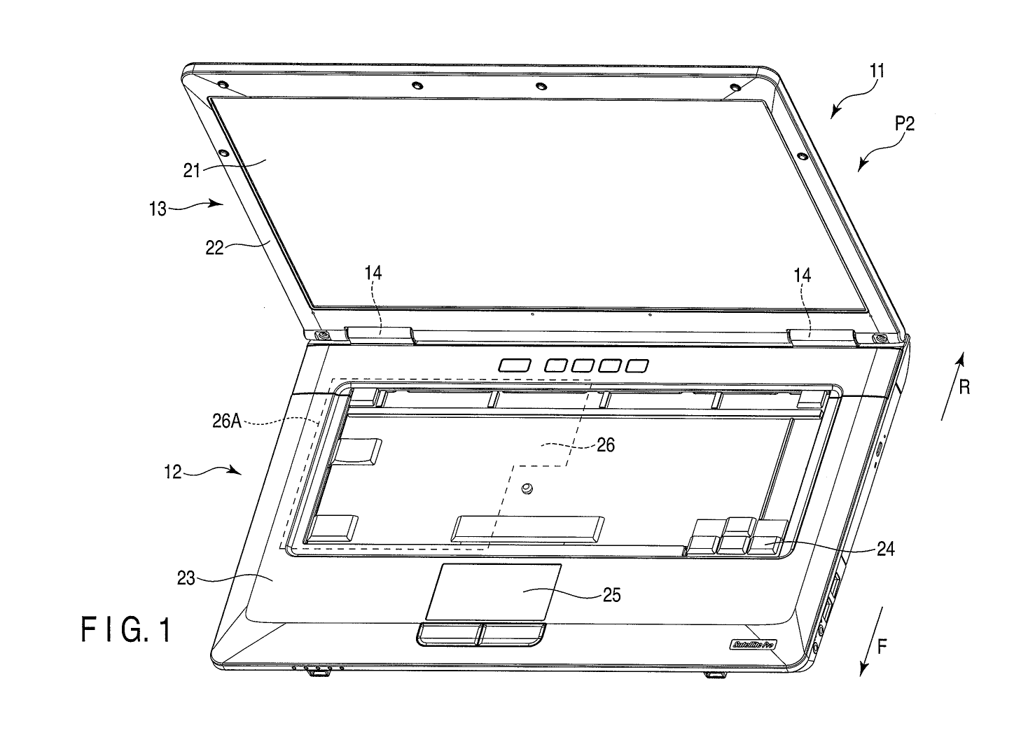

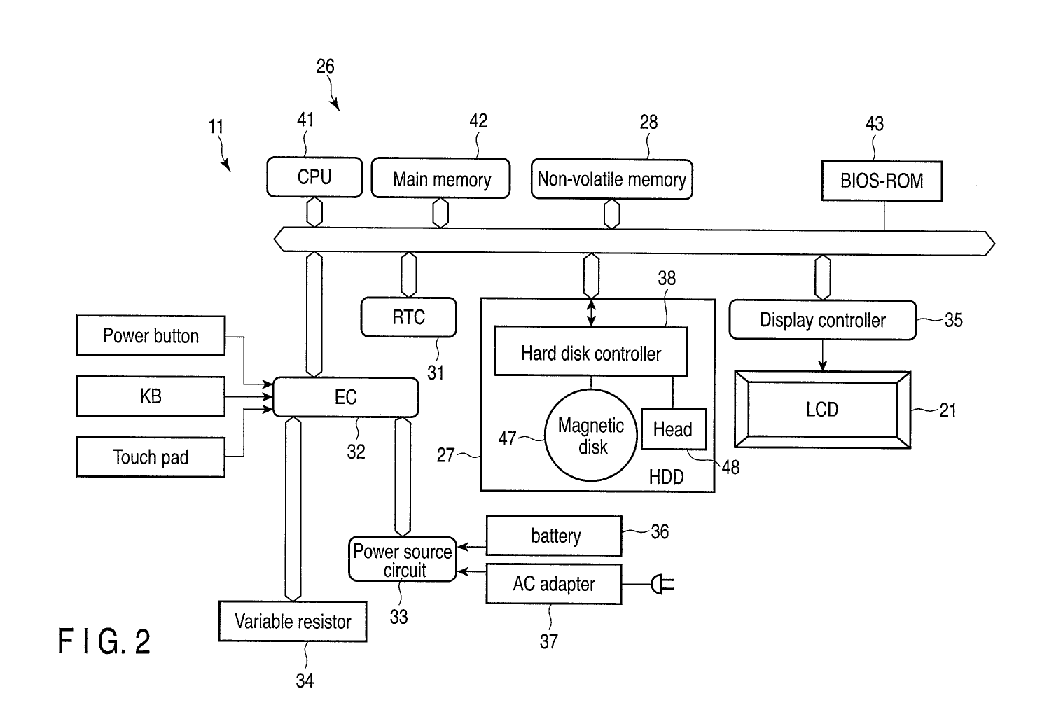

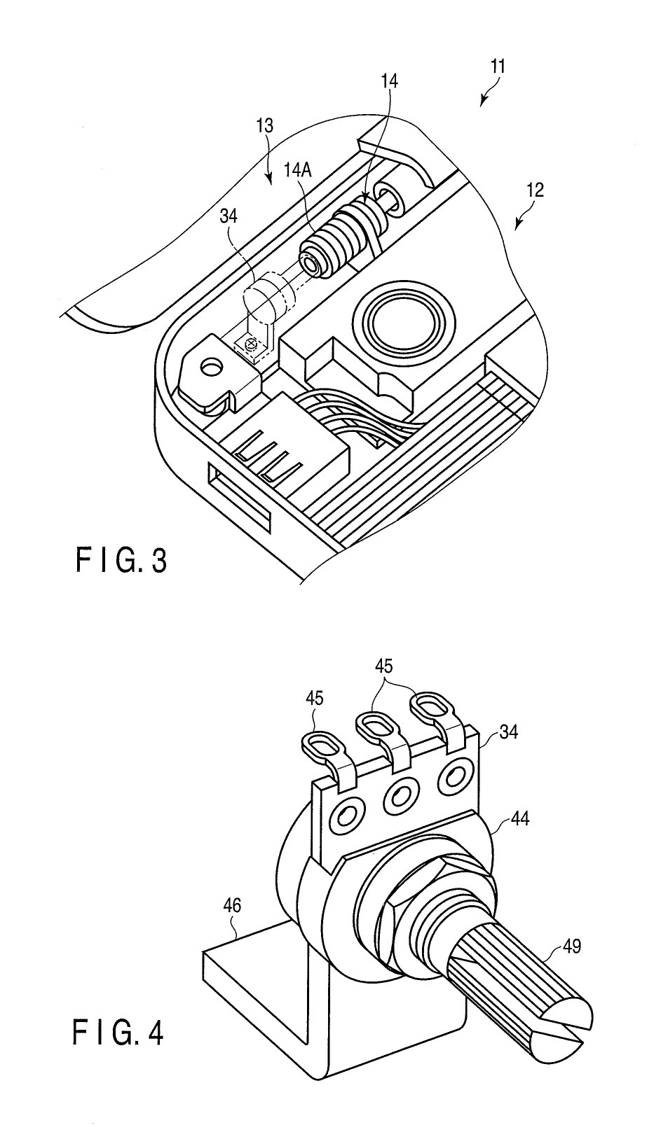

In general, according to one embodiment, an electronic device includes a main body unit, a hard disk drive housed inside the main body unit and including a head which performs reading and writing of data to a magnetic disk, a display unit pivotable between a first position where the display unit is laid parallel to the main body unit and a second position where the display unit is raised relative to the main body unit, a sensor which senses an angle at which the display unit is positioned, and a control unit. The control unit retracts the head to a retraction position when the sensor senses a change in the angle of the display unit. A description will now be given of an electronic device according to the first embodiment, with reference to FIGS. 1 to 5. In this specification, the near side to the user (that is, user side) is defined as front F, the far side from the user is rear R, the left-hand side of the user is left, the right-hand side of the user is right, the upper side from the user's position is up and the lower side from the user's position is down.

As shown in FIG. 1, a portable computer 11 which is an example of an electronic device comprises a main body unit 12, a display unit 13, and hinge portions 14 provided between the main body unit 12 and the display unit 13. The hinge portions 14 support the display unit 13 such as to be pivotable. The display unit 13 is pivotable between a first position P1 where the display unit 13 is laid parallel to the main body unit 12 and a second position P2 where the display unit 13 is raised relative to the main body unit 12.

The display unit 13 comprises a display unit 21 and a synthetic resin-made display case 22 which surrounds the display unit 21. In this embodiment, a liquid crystal display is used as an example of the display unit 21. The display case 22 may be made of metal.

As shown in FIG. 1 to FIG. 4, the main unit 12 comprises a box-like main body case 23 formed by synthetic resin, a keyboard 24 and a touch pad 25, which are mounted on the main body case 23, and a printed circuit board 26 housed inside the main body case 23. FIG. 1 shows the keyboard 24 except a part of keys.

The main body unit 12 comprises a hard disk drive (HDD) 27, a non-volatile memory 28, a real time clock (RTC) 31, an embedded controller (EC) 32, a power circuit 33, a variable resistor 34, a display controller 35 and a battery 36 inside the main body case. The main body unit 12 externally comprises an AC adapter 37.

The printed circuit board 26 comprises a printed wiring board 26A, a CPU 41 mounted on the printed wiring board 26A, a main memory 42 mounted on the printed wiring board 26A, and a BIOS-ROM 43 mounted on the printed wiring board 26A. The control unit according to the present embodiment includes, for example, the CPU 41, the main memory 42, the non-volatile memory 28, the BIOS-ROM 43, the EC 32, a filter driver which is software, a hard disk controller 38, and the display controller 35.

The variable resistor 34 is fixed, for example, to one of the end portions of a shaft portion 14A of the hinge portion 14. The variable resistor 34 is an example of a sensor which senses an angle at which the display unit 13 is positioned. The variable resistor 34 varies the resistance within the range of 0 to 100Ω. The angle at which the display unit 13 is positioned is measured by using the resistance (absolute value). For example, if the display unit 13 is raised to 90° relative to the main body unit 12, the resistance is set to be 50Ω.

As shown in FIG. 4, the variable resistor 34 comprises a main body portion 44, a rotating shaft 49, a terminal 45 projecting from the main body portion 44, and an L-shaped fixing portion 46 projecting from the main body portion 44, for example. The variable resistor 34 also serves as a detection switch which detects that the display unit 13 is positioned in the first position P1. That is, the control unit determines that the display unit 13 is closed when the resistance sensed by the variable resistor 34 is 5Ω or less. The hard disk drive 27 comprises a magnetic disk 47 and a head 48 which writes data to the magnetic disk 47.

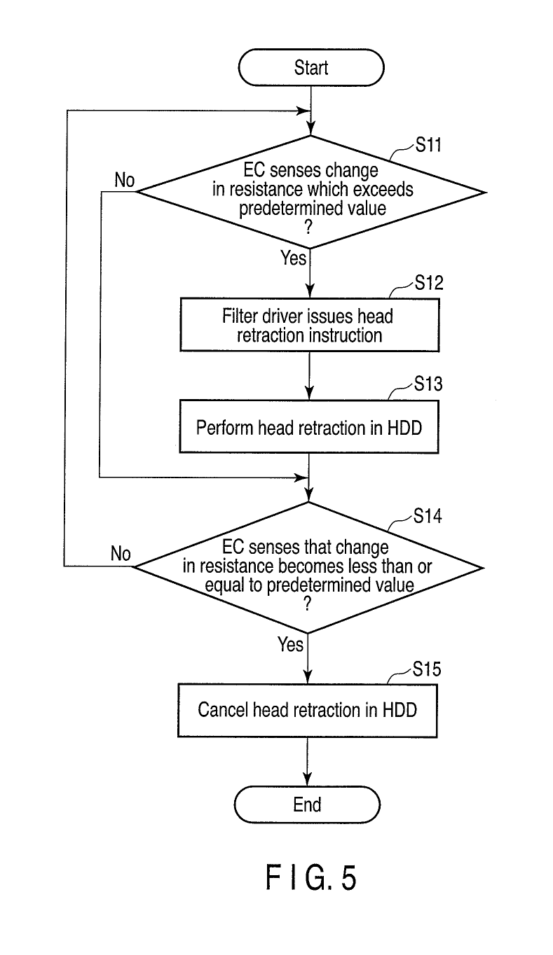

Next, the control of head retraction of the hard disk drive 27 of the present embodiment will be explained with reference to FIG. 5.

First, suppose that the user moves the display unit 13 to adjust the angle of the display unit 13. If the EC 32 detects a change in resistance which exceeds a predetermined value (step S11), the filter driver of the control unit issues an instruction for head retraction (step S12). In response to the instruction for head retraction, the head 48 is moved to the retraction position to retract the head from the magnetic disk in the hard disk drive 27 (step S13). If the EC 32 detects a change in resistance which is less than or equal to the predetermined value after a predetermined time has elapsed from the movement of the display unit 13 (step S14), the filter driver of the control unit cancels head retraction in the hard disk drive 27 (step S15). When the EC 32 does not detect a change in resistance which is greater than or equal to a predetermined value in step S11, the EC 32 confirms again that the change in resistance is less than or equal to the predetermined value in step S14, and cancels head retraction in the hard disk drive 27.

According to the first embodiment, the portable computer 11 comprises the main body unit 12, the hard disk drive 27 housed in the main body unit 12 and comprising a head 48 which writes data to the magnetic disk 47, the display unit 13 pivotable between the first position P1 where the display unit 13 is laid parallel to the main body unit 12 and the second position P2 where the display unit 13 is raised relative to the main body unit 12, the sensor which senses an angle at which the display unit 13 is positioned, and the control unit which retracts the head 48 to the retraction position when the sensor senses a change in the angle of the display unit 13.

With this structure, right after the sensor detects movement of the display unit 13, the control unit can move the head 48 to the retraction position in anticipation of shock. In this manner, when the user changes the angle of the display unit 13, for example, failure of the magnetic disk 47 of the hard disk drive 27 can be prevented.

In this embodiment, the variable resistor 34 functions as the sensor. This structure realizes a sensor with a simple structure at low cost. In addition, the sensor also serves as a detection switch which detects that the display unit 13 is in the first position P1. This eliminates the need to employ an additional detection switch, and decreases the number of types of component.

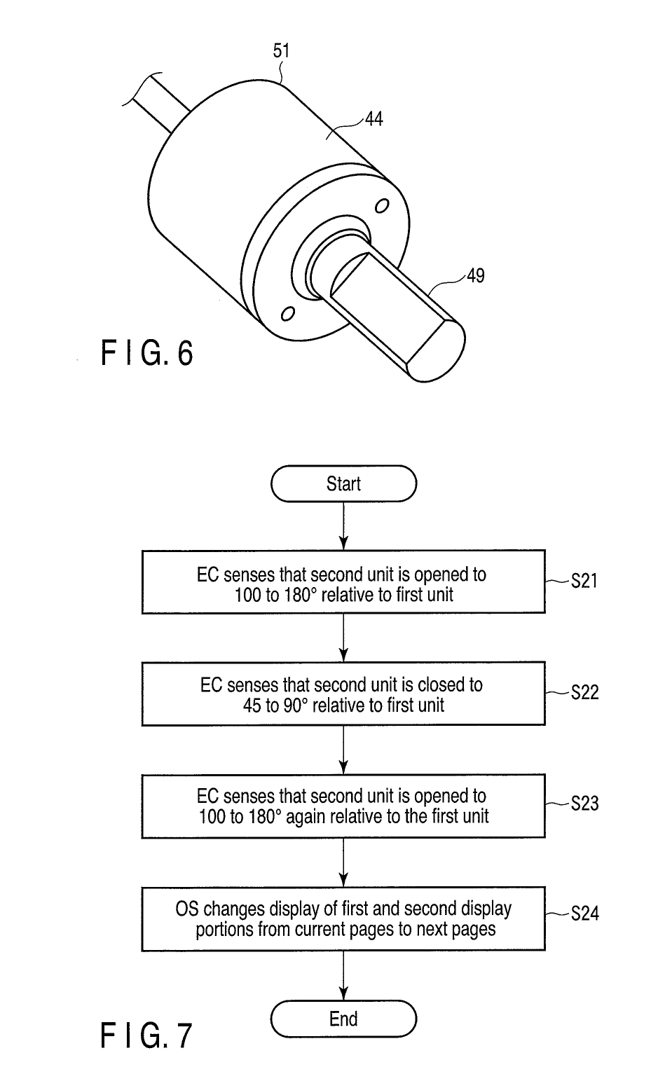

A description will now be given of an electronic device according to the second embodiment, with reference to FIG. 6. The structures of a portable computer 11 which is an example of the electronic device of the second embodiment are similar to the structures described in the first embodiment except that a rotary encoder is used instead of the variable resistor. The following descriptions will therefore focus mainly on how the second embodiment differs from the first embodiment. The structural components or elements that are similar to those of the first embodiment will be denoted by the same reference symbols, and a repetitive description of such components or elements will be omitted. The portable computer 11 has the same appearance as that of the first embodiment shown in FIG. 1.

In this embodiment, a rotary encoder 51 is used as an example of a sensor. The rotary encoder 51 comprises a main body portion 44 and a rotating shaft 49 projecting from the main body portion 44. The main body portion 44 is fixed to a main body case 23 by, for example, a screw. With the portable computer 11 of the second embodiment, if an EC 32 detects the pulse of the rotary encoder 51, a filter driver of a control unit issues an instruction for head retraction. This structure realizes retraction of a head 48 to the safe position in anticipation of shock transmitted to a hard disk drive 27.

According to the present embodiment, the sensor which is the rotary encoder 51 can be realized with a simple structure at low cost.

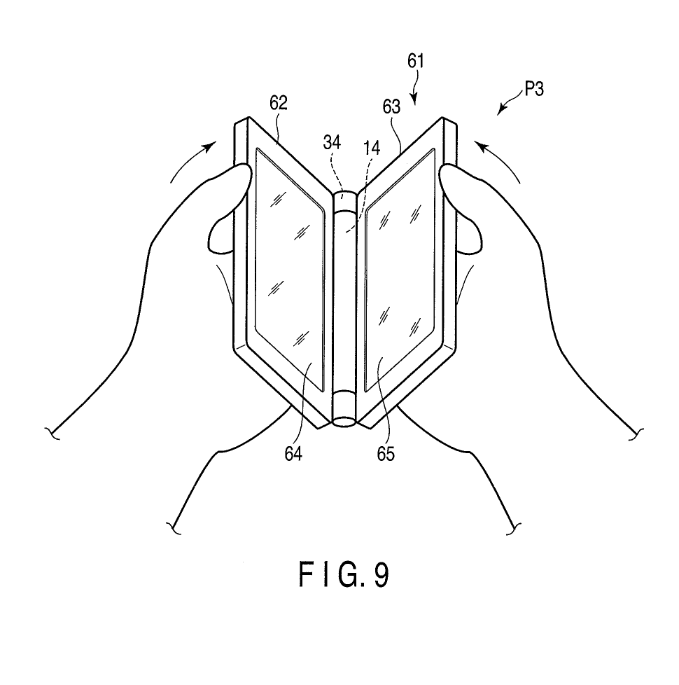

A description will now be given of an electronic device according to the third embodiment, with reference to FIGS. 7-10. An electronic book which is an example of the electronic device of the third embodiment has the different appearance from the device of the first embodiment, but is similar to the device of the first embodiment in the inner structure and the other structures. The following descriptions will therefore focus mainly on how the third embodiment differs from the first embodiment. The structural components or elements that are similar to those of the first embodiment will be denoted by the same reference symbols, and a repetitive description of such components or elements will be omitted.

An electronic book 61 which is used for user's reading displays documents such as a novel stored in an installed storage device on a first display portion and a second display portion.

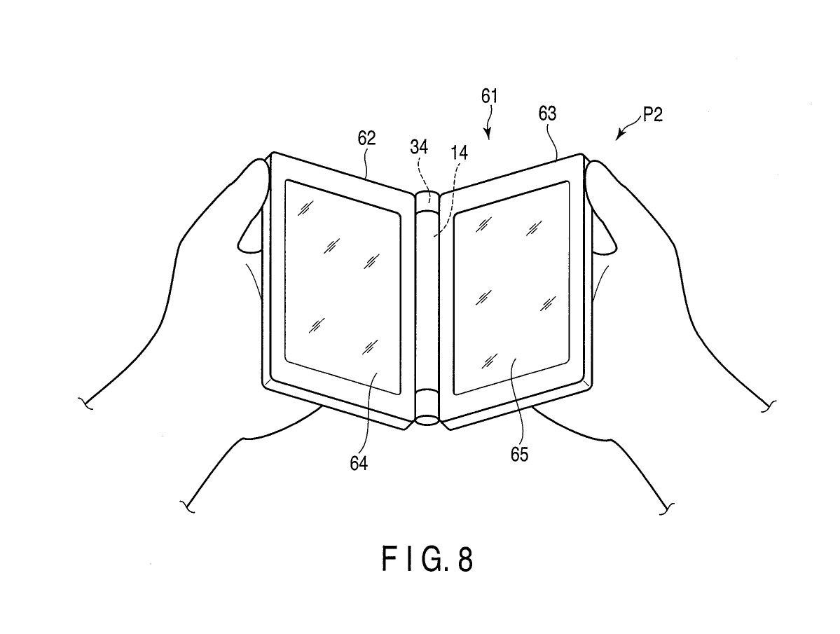

As shown in FIG. 8, the electronic book 61 comprises a first unit 62 including a first display portion 64, a second unit 63 including a second display portion 65, and a hinge portion 14 provided between the first unit 62 and the second unit 63. The hinge portion 14 connects the first unit 62 and the second unit 63 so that the second unit 63 is laid parallel to or raised relative to the first unit 62. That is, the second unit 63 is pivotable between a first position P1 where the second unit 63 is laid parallel to the first unit 62, a second position P2 where the second unit 63 is raised relative to the first unit 62, and a third position P3 which is substantially the middle between the first position P1 and the second position P2. The first display portion 64 and the second display portion 65 are, for example, liquid crystal displays.

An operation of paging forward of the electronic book 61 according to the present embodiment will now be explained with reference to FIGS. 7-9. First, as shown in FIG. 8, when the second unit 63 is in the second position P2, an EC 32 detects that the second unit 63 is opened to 100 to 180° relative to the first unit 62 via a variable resistor 34 (step S21). At this time, the resistance ranging between 50 to 90Ω should be measured. In this state, the first display portion 64 and the second display portion 65 show, for example, the first page and the second page (current pages).

Next, if the second unit 63 is moved to the third position P3 by user's closing the first unit 62 and the second unit 63, the EC 32 detects that the second unit 63 is closed to 45 to 90° relative to the first unit 62, for example (step S22). At this time, the resistance ranging between 22.5 to 45Ω should be measured.

Then, if the second unit 63 is moved again to the second position P2 by user's opening the first unit 62 and the second unit 63, the EC 32 detects that the second unit 63 is opened to 100 to 180° relative to the first unit 62, for example (step S23). At this time, the resistance ranging between 50 to 90Ω should be measured.

If steps S21 to S23 are performed within a predetermined time period, for example, within one second in this embodiment, the control unit (OS) detects that user's operation of paging forward. In this case, the control unit (OS) changes display of the first display portion 64 and the second display portion 65 from the first and second pages (current pages) to the third and fourth pages (next pages) (step S24).

An operation of paging back will now be explained. First, the EC 32 detects that the second unit 63 is opened, for example, to 100 to 180° relative to the first unit 62 in normal reading. In this state, the first display portion 64 and the second display portion 65 show the third and fourth pages (current pages) of the document.

If the user completely closes the second unit 63 to be laid parallel to the first unit 62, the EC 32 detects that the second unit 63 is moved to the first position P1. Then, if the second unit 63 is moved again to the second position P2 by user's opening the first unit 62 and the second unit 63, the EC 32 detects that the second unit 63 is opened to 100 to 180° relative to the first unit 62, for example. If these steps are performed within a predetermined time period, for example, within one second in this embodiment, the control unit (OS) detects that user's operation of paging back. In this case, the control unit (OS) changes display of the first display portion 64 and the second display portion 65 from the third and fourth pages (current pages) to the first and second pages (previous pages). The paging back is performed by the above steps.

According to the present embodiment, the electronic book 61 comprises the first unit 62 which includes the first display portion 64, the second unit 63 which is pivotable between the first position P1 where the second unit 63 is laid parallel to the first unit 62, the second position P2 where the second unit 63 is raised relative to the first unit 62, and the third position P3 which is substantially the middle between the first position P1 and the second position P2 and includes a second display portion 65, and the control unit which displays the relevant pages of the document on the first display portion 64 and the second display portion 65, and displays the next pages following the relevant pages on the first display portion 64 and the second display portion 65 when the second unit 63 is moved from the second position P2 to the third position P3 and returned to the second position P2 within the predetermined time period.

In the above-mentioned structure, if the user moves the second unit 63 from the second position P2 which is an opened state to the third position P3 which is a half-opened state, and moves the second unit 62 back to the second position P2, the paging forward of documents is realized easily. Therefore, the user can perform easy and immediate paging forward without using the icon for paging forward, for example, on the first display portion 64 and the second display portion 65.

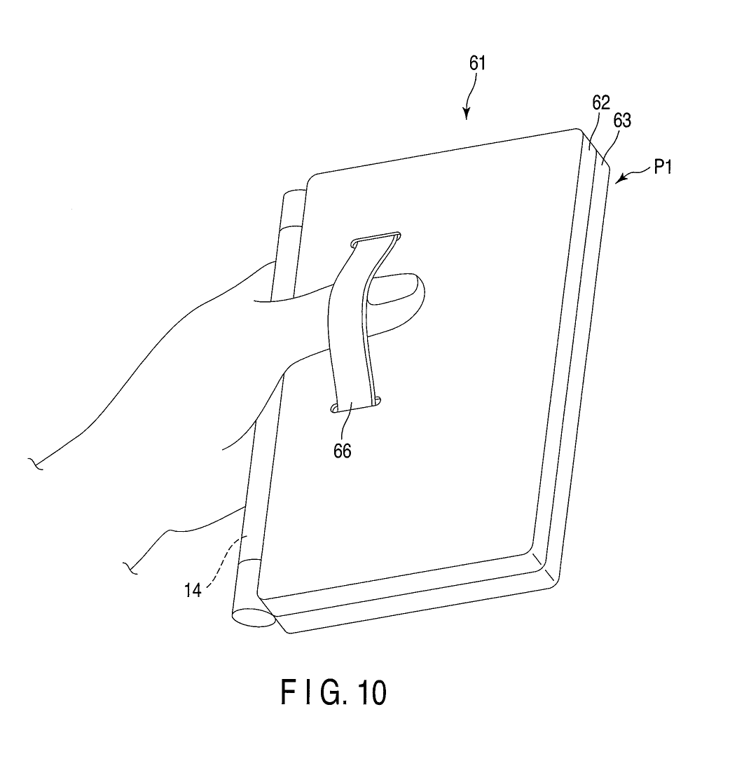

As shown in FIG. 10, the electronic book 61 may be provided with belts 66 attached to the first unit 62 and the second unit 63 to support the electronic book 61 by inserting fingers into the belts. If the belts 66 are provided, the user can open or close the electronic book 61 by one hand (left hand). In addition, if a required power for opening or closing the first unit 62 and the second unit 63 is small, and the weight of the second unit 63 is sufficiently large, the belt 66 is not necessarily provided to the second unit 63.

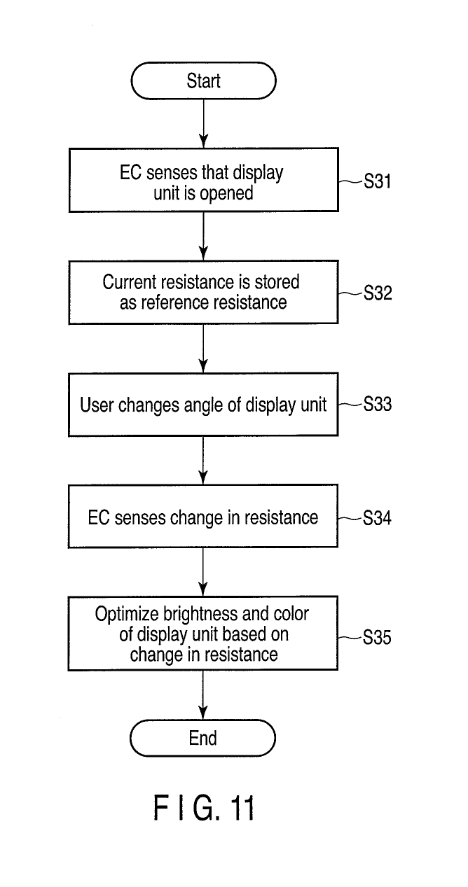

A description will now be given of an electronic device according to the fourth embodiment, with reference to FIG. 11. The structures of a portable computer 11 which is an example of the electronic device of the fourth embodiment are similar to the structures described in the first embodiment except that the brightness of a display unit 21 is controlled instead of retracting the head 48 of the hard disk drive 27. The following descriptions will therefore focus mainly on how the second embodiment differs from the first embodiment. The structural components or elements that are similar to those of the first embodiment will be denoted by the same reference symbols, and a repetitive description of such components or elements will be omitted. The portable computer 11 has the same appearance as that of the first embodiment shown in FIG. 1.

In the fourth embodiment, the EC 32 first detects that a display unit 13 is opened in normal use as shown in FIG. 1 (step S31). In this state, the current resistance detected by the EC 32 through a variable resistor 34 is stored as a reference resistance in a main memory 42, for example (step S32). If the user changes the angle of the display unit 13 (step S33), the EC 32 detects the resistance through the variable resistor 34 (step S34). Further, the control unit (OS) optimizes the brightness and color of the display unit 21 based on the difference between the current resistance and the reference resistance so that the user can easily view the display (step S35). To be specific, if the display unit 13 is inclined relative to the user's eyes, the control unit controls the brightness to be high and the color to be deep.

According to the fourth embodiment, the portable computer 11 comprises a main body unit 12, a display unit 13 which is pivotable between a first position P1 where the display unit 13 is laid parallel to the main body unit 12 and a second position P2 where the display unit 13 is raised relative to the main body unit 12 and comprises the display unit 21, a sensor which senses the angle at which the display unit 13 is positioned, and a control unit which adjusts the brightness and color of the display unit to provide the user with clear view when the sensor senses a change in the angle of the display unit 13.

This structure automatically adjusts the brightness and color of the display unit 21 so that the user can easily view the display even when the angel of the display unit 13 is changed. Therefore, the visibility of the display unit 21 can be improved even when the user changes the angle of the display unit 13 without individually making fine adjustment for the brightness and color.

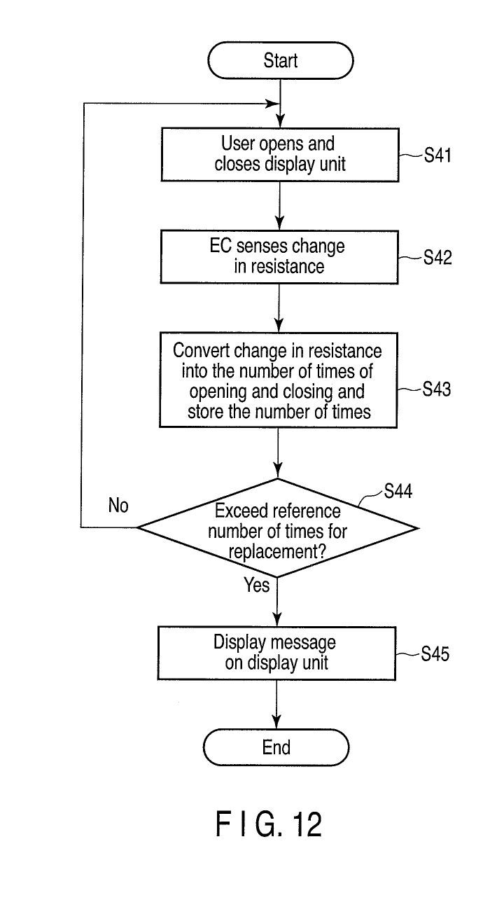

A description will now be given of an electronic device according to the fifth embodiment, with reference to FIG. 12. The structures of a portable computer 11 which is an example of the electronic device of the fifth embodiment are similar to the structures described in the first embodiment except that the number of times that the display unit 13 is opened and closed is measured based on the change in resistance instead of retracting the head 48 of the hard disk drive 27. The following descriptions will therefore focus mainly on how the fifth embodiment differs from the first embodiment. The structural components or elements that are similar to those of the first embodiment will be denoted by the same reference symbols, and a repetitive description of such components or elements will be omitted. The portable computer 11 has the same appearance as that of the first embodiment shown in FIG. 1.

In the fifth embodiment, the change in resistance measured by a variable resistor 34 is used to count the number of times of opening and closing the display unit 13. The portable computer 11 houses a storage unit such as a non-volatile memory 28 and a hard disk drive 27 inside the main body unit 12.

The user usually uses the portable computer by opening or closing the display unit 13 (step S41). The EC 32 detects the change in resistance through the variable resistor (step S42). The change in resistance detected by the EC 32 is converted into the number of times of opening and closing the display unit 13 by the control unit (OS), and the number of times of opening and closing is accumulated in the storage unit such as the non-volatile memory 28 and the hard disk drive 27 (step S43). The control unit determines whether the accumulated value is greater than or equal to the reference value for determining replacement (step S44). If the accumulated value is greater than or equal to the reference value, the control unit displays a message such as “please contact a user support desk” on the display unit 21 (step S45). The accumulated value may remain stored in the non-volatile memory 28 or the hard disk drive 27 without being used to display a specific message on the display unit 21, and may be used to determine the necessity of replacement of a hinge portion 14 when the manufacturer takes back the portable computer for repair.

If the accumulated value is less than or equal to the reference value, the control unit continuously converts the change in resistance into the number of times of opening and closing and accumulates the number of times of opening and closing, for example, in the non-volatile memory 28 or the hard disk drive 27 (step S44).

According to this embodiment, the portable computer 11 comprises the main body unit 12, the display unit 13 which is pivotable between a first position P1 where the display unit 13 is laid parallel to the main body unit 12 and a second position P2 where the display unit 13 is raised relative to the main body unit 12, the variable resistor 34 which detects the angle of the display unit 13 based on the change in resistance, and a storage unit which is housed inside the main body unit 12 and accumulates the change in resistance detected by the variable resistor 34.

In this structure, the change in resistance detected by the variable resistor 34 can be used to determine replacement of the hinge portion 14.

The electronic device is not limited to the portable computer as described in the above embodiments and may be different electronic devices such as a cellular phone. Furthermore, it is only natural that the electronic device of the present invention can be remodeled into various different versions as long as the essence of the invention does not fall outside the scope thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a main body;
a hard disk drive in the main body comprising a head configured to read data from a magnetic disk and to write data to the magnetic disk;
a display configured to pivot between a first position where the display is in parallel to the main body and a second position where the display is not parallel to the main body;
a sensor configured to sense an angle between the second position of the display and the main body;
a controller configured to retract the head to a retraction position when the sensor senses a change in the angle.

2. The electronic device of claim 1, wherein the sensor is a variable resistor.

3. The electronic device of claim 2, wherein the sensor is a detection switch configured to detect that the display is in the first position.

4. The electronic device of claim 1, wherein the sensor is a rotary encoder.

5. An electronic device comprising:
a first portion comprising a first display portion;
a second portion configured to pivot between a first position where the second portion is in parallel to the first portion, a second position where the second portion is not parallel to the first portion and a third position which is substantially a middle position between the first position and the second position, the second portion comprising a second display portion; and
a controller configured to display one or more pages of a document on the first display portion and the second display portion, and to display next pages following the one or more pages on the first display portion and the second display portion when the second portion is moved from the second position to the third position and returned to the second position within a predetermined time period.

6. An electronic device comprising:
a main body;
a display configured to pivot between a first position where the display is in parallel to the main body and a second position where the display is not parallel to the main body;
a variable resistor configured to sense an angle of the display based on a change in resistance; and
a storage module in the main body configured to accumulate a change in resistance detected by the variable resistor.
